(19) United States
(12) Patent Application Publication
(10) Pub. No.: US 2013/0207790 A1
(43) Pub. Date: Aug. 15, 2013

(54) FINGER BEAMZ

(71) Applicants: Kevin Corson, Springfield, OR (US); Charles Mollo, Scottsdale, AZ (US)

(72) Inventors: Kevin Corson, Springfield, OR (US); Charles Mollo, Scottsdale, AZ (US)

(73) Assignee: BEAMZ INTERACTIVE, INC., Scottsdale, AZ (US)

(21) Appl. No.: 13/766,546

(22) Filed: Feb. 13, 2013

Related U.S. Application Data
(60) Provisional application No. 61/598,744, filed on Feb. 14, 2012.
(60) Provisional application No. 61/659,698, filed on Jun. 14, 2012.

(51) Int. Cl. G08C 19/16

(52) U.S. Cl. CPC G08C 19/16
USPC 340/12.54

(57) ABSTRACT

A multi-media controller configured to generate MIDI signals which may be worn on a finger of a user. The controller has at least one electronic beam extending between a pair of expandable and retractable members. Each controller is connectable to a portable appliance operating software and which generates audio sounds, allowing a user to play an instrument of a song by interrupting the beam. Multiple controllers may be interconnected by a hub allowing multiple users to jam along by playing different instruments in a song.

### CLAIM OF PRIORITY

This application claims priority of U.S. Provisional Patent Application Ser. No. 61/598,744, filed Feb. 14, 2012, entitled “Finger Beamz”, and U.S. Provisional Patent Application Ser. No. 61/659,698 filed Jun. 14, 2012, entitled “Finger Beamz” the teachings of which are incorporated herein by reference.

### FIELD OF INVENTION

The present invention is generally directed to multi-media devices including controllers and user interfaces.

### BACKGROUND

Multi-media controllers and user interfaces are typically operable to control and produce audio, video and other visually displayed media. As the complexity of multi-media devices increases, it is important to provide a user interface and controller that allows a user to naturally and intuitively interact with a system, efficiently, without becoming overwhelmed by the numerous features and control signals involved.

Portable electronic devices such as mobile phones and tablets are configured to run gaming applications, many of which are controlled by the device itself via a touch screen and/or user buttons. A separate controller configured to operate a gaming application on the device can provide enhanced operability of some gaming applications and enjoyment by the user.

### BRIEF DESCRIPTION OF THE FIGURES

FIG. 1 is a top perspective view of a one embodiment of the invention in the closed retracted position;

FIG. 2 is a top perspective view of one embodiment of the invention in the open position;

FIG. 3 is a side view of the embodiment of FIG. 2;

FIG. 4 is a front view of the embodiment of FIG. 2;

FIG. 5 is the other side view of the embodiment of FIG. 2;

FIG. 6 is top view of the embodiment of FIG. 2 in the open position; and

FIG. 7 is a block diagram of a plurality of devices interconnected via a communications hub.

### DETAILED DESCRIPTION OF THE PREFERRED EMBODIMENT

Applicant incorporates by reference the teachings of commonly assigned U.S. Pat. No. 7,504,577 B2 entitled Music Instrument System and Methods, which discloses several embodiments of a controller having a plurality of electromagnetic beams that can be interrupted by a user to selectively generate musical sounds. The controller is responsive to signals generated by receivers indicative of an associated interrupted beam and generates signals, such as MIDI signals, that are configured to generated sympathetic musical sounds.

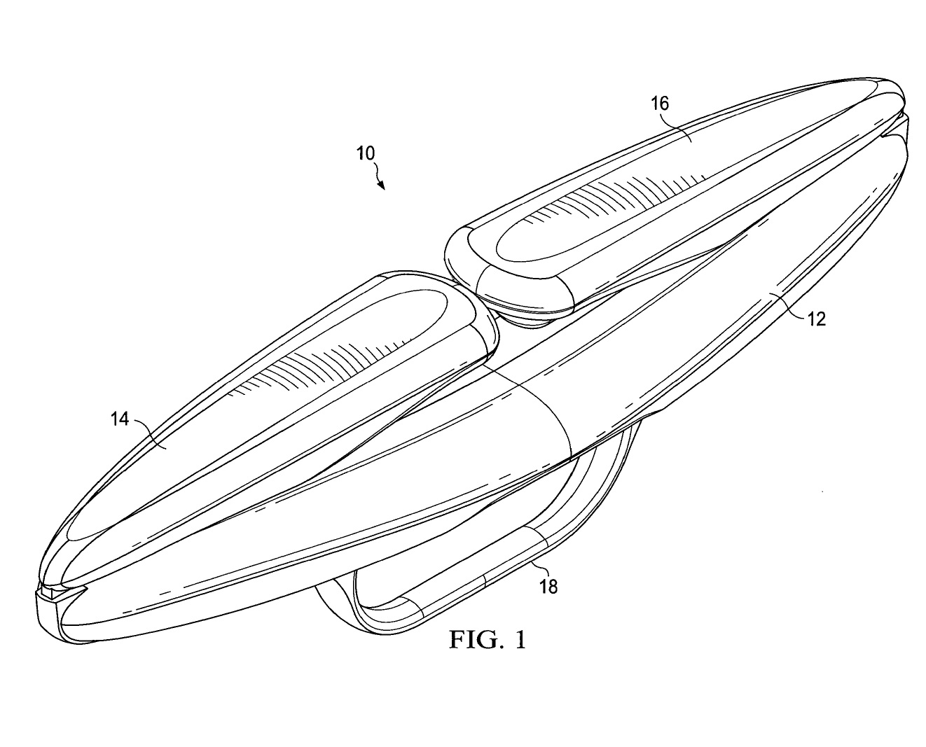

FIG. 1 shows a top perspective view of portable controller 10 according to a first embodiment of the invention having a single beam and that may attached to a user's finger, which controller 10 responsively generates a MIDI output signal or signals as a function of the beam being broken. The controller 10 is operable to generate MIDI signals, such as taught in U.S. Pat. No. 7,504,577 B2. The MIDI signals may be sent by wire or wirelessly to a host appliance running an application configured to process the received signals, and responsively generate multi-media outputs including audio, video or other signals. The host appliance may be, for instance, a mobile phone, tablet or other electronic device. The application may be a gaming application, or a music application such as offered by Beamz Interactive, Inc. of Scottsdale, Ariz. The controller 10 is seen to comprise an elongated body member 12 and a pair of opposing rotatable side members 14 and 16 in the retracted position, and a finger loop 18 coupled to a bottom portion of the body member 12 configured to be received and supported by a user's finger.

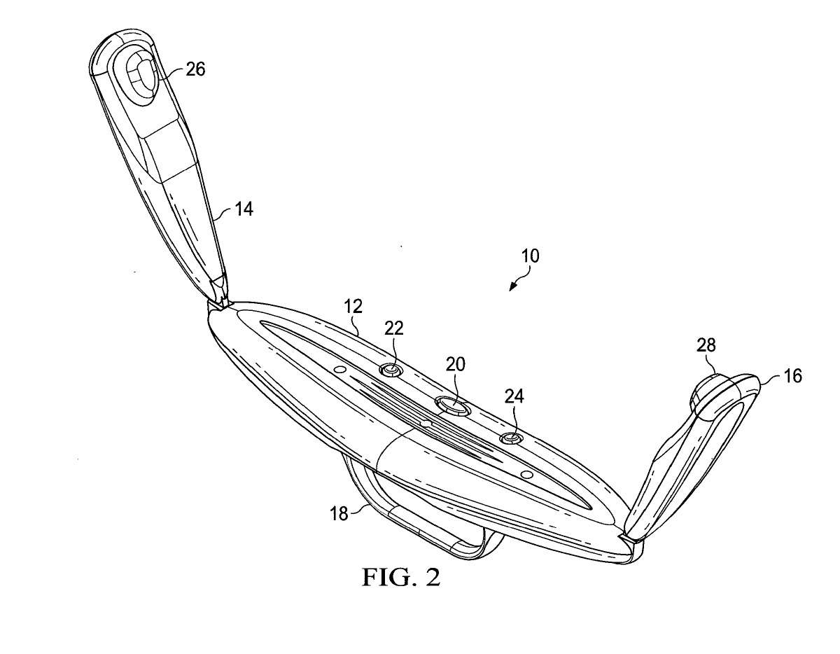

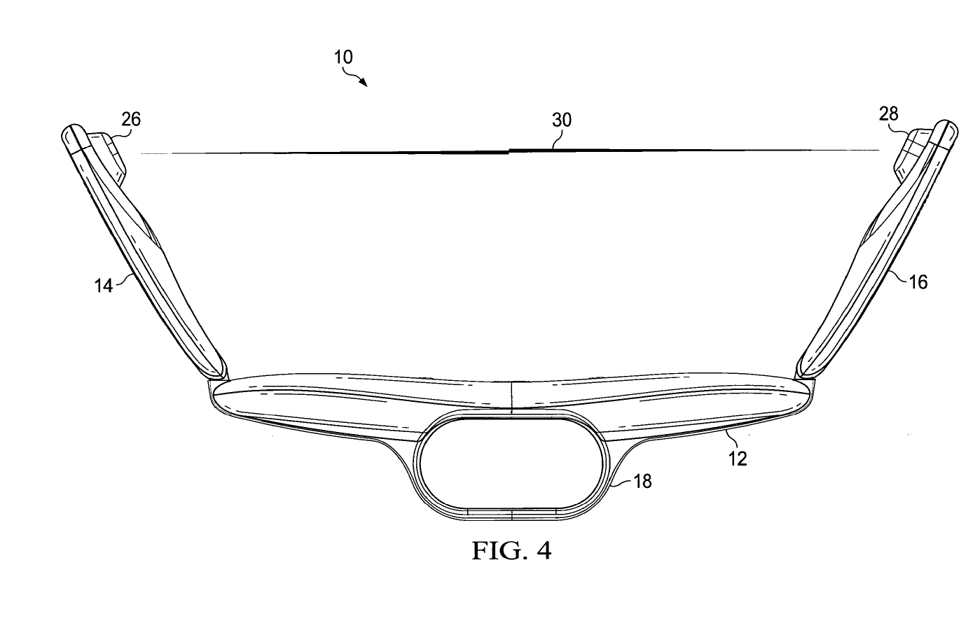

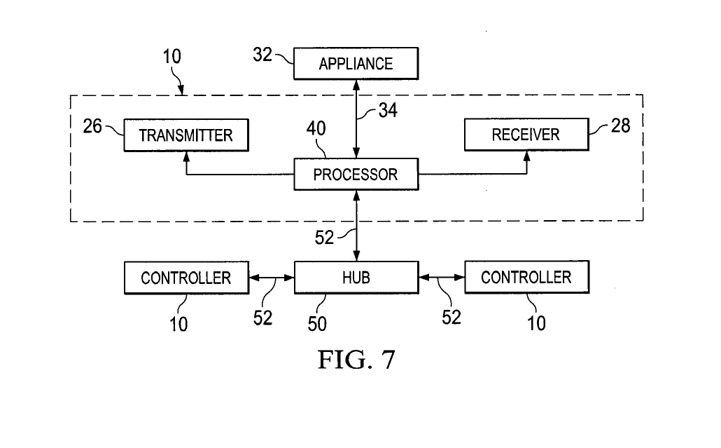

FIG. 2 shows the controller 10 in the open operable position with the side members 14 and 16 extended. The base member 12 is seen to comprise of a plurality of control buttons, with button 20 controlling power, button 22 configured to advanced an instrument being played by the controller, and button 24 configured to select backwards the instrument being played. A total of 6 different musical instruments may configured to be played by the controller, although limitation to this number is not to be inferred. Side member 14 includes an electromagnetic transmitter 26, such as an LED transmitter, and side member 16 has a corresponding receiver/sensor 28, whereby a beam 30 generated by transmitter 26 extends to receiver/sensor 28, such as shown in FIG. 4. The controller 10 generates the MIDI signals when the beam 30 is interrupted, and transmits the MIDI signals to a host appliance 32 via link 34 as shown in FIG. 7. The host appliance may be a PDA, a mobile phone, tablet, or other portable electronic appliance, which appliance has audio and/or video generating capabilities. The appliance 32 includes controller software and is configured to play a selected song from a library, whereby the appliance 32 advances the song being played by the controller(s) 10.

As shown in FIG. 7, a plurality of controllers 10 can be linked together via links 52 through a hub 50, such as 6 controllers. Each controller 10 has a processor 40 that may be, for instance, linked by Bluetooth or other wireless, or wire line, to one another via the hub 50. Alternatively, each controller may be linked to one another via the portable appliance 32. Each controller 10 is configured to allow a user to play along with one master track run by the appliance 32, and each user operating a respective controller 10 can control 2 patches of the song/track each, while hearing the other patches being played by the other 5 controller players, such that a group can jam along together. This feature is enjoyable by younger kids as they interact with one another, but this controller is also suited for individuals with disabilities or in rehabilitation as it is easy to use.

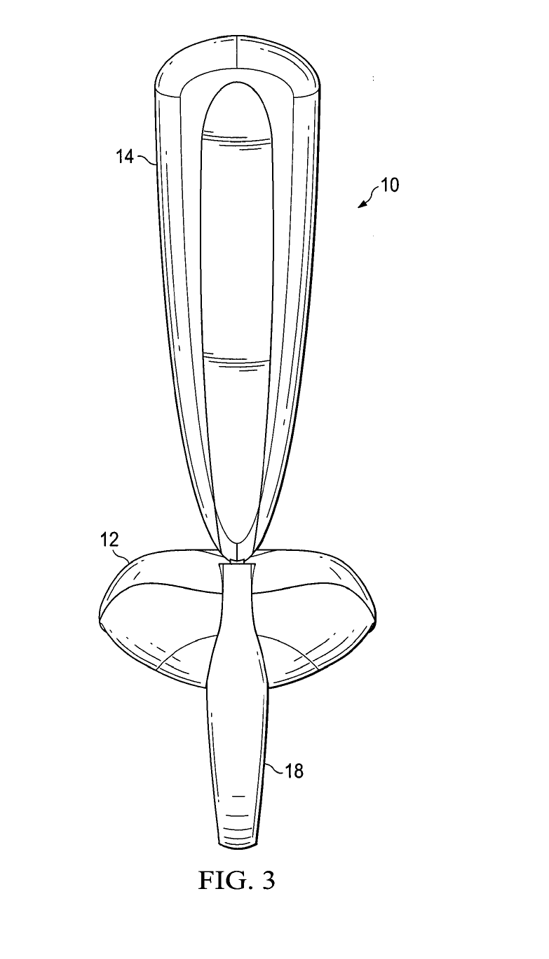

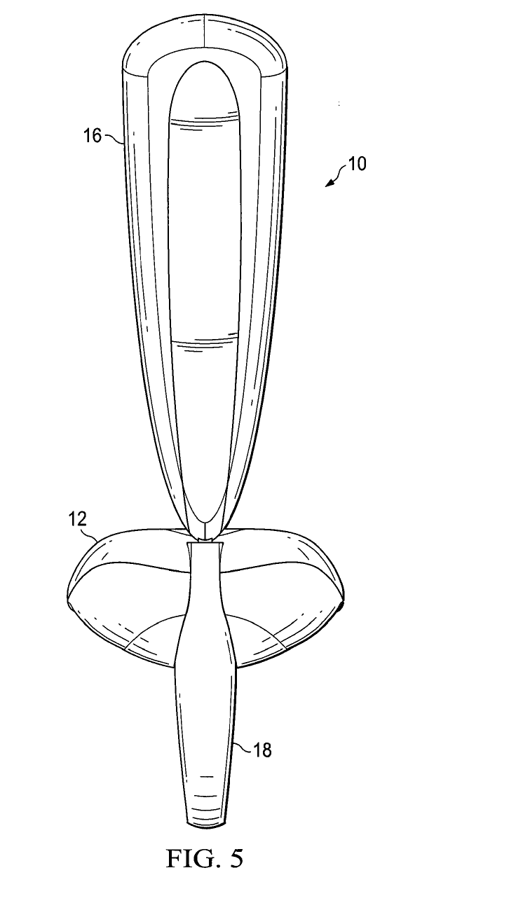

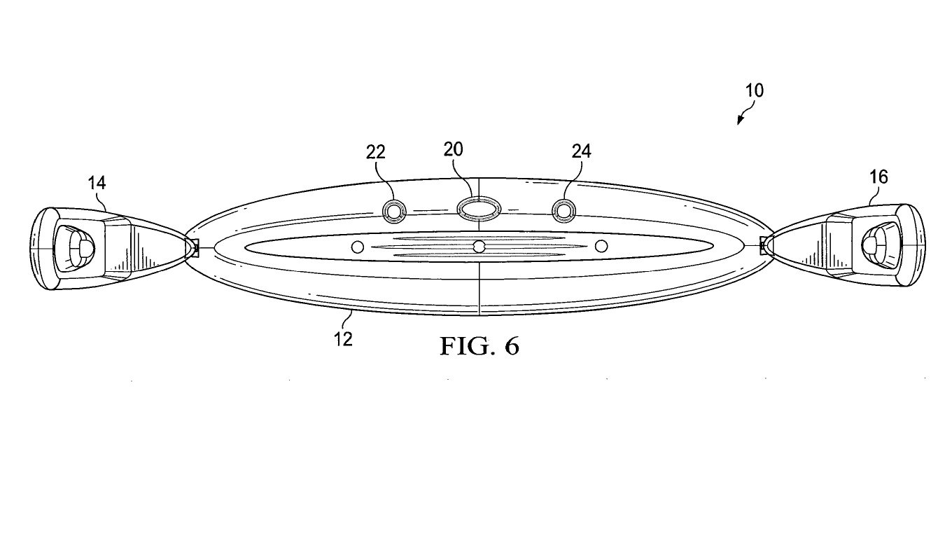

FIG. 3 shows an end view of controller 10, FIG. 4 shows a front view of the controller 10, FIG. 5 shows the opposing end view of controller 10, and FIG. 6 shows a top view of the controller 10.

The foregoing description is presented to enable one of ordinary skill in the art to make and use the invention and is provided in the context of a patent application and its requirements. Various modifications to the preferred embodiment of the system, and the general principles and features of the system and methods described herein will be readily apparent to those of skill in the art. Thus, the present invention is not to be limited to the embodiments of the system and methods described above and illustrated in the drawing figures, but is to be accorded the widest scope consistent with the spirit and scope of the appended claims.

1. A multi-media controller, comprising:
a body member;
a first member rotatably coupled to the body member and an opposing second member rotatably coupled to the body member, each of the first and second members having a retracted position and an expanded position, the first member comprising a transmitter configured to generate an electromagnetic signal and the second member having a receiver configured to receive the electromagnetic signal and generate a sensor signal indicative of receiving or not receiving the electromagnetic signal; and
a processor configured to receive the sensor signal from the receiver and generate a plurality of MIDI signals configured to generate a multi-media output.
